(19) United States
(12) Patent Application Publication
(10) Pub. No.: US 2009/0175290 A1
(43) Pub. Date: Jul. 9, 2009

(54) Flexray communications module, flexray communications controller, and method for transmitting messages between a flexray communications link and a flexray participant

(76) Inventors: Josef Newald, Stuttgart (DE); Markus Ihle, Jettenburg (DE); Eugen Becker, Backnang (DE)

Correspondence Address: KENYON & KENYON LLP, ONE BROADWAY, NEW YORK, NY, 10004, US

(21) Appl. No.: 11/989,281

(22) PCT Filed: Jul. 20, 2006
(86) PCT No.: PCT/EP2006/064471

§ 371 Date: Mar. 19, 2009

(30) Foreign Application Priority Data
Jul. 21, 2005 (DE) 10 2005 034 744.4
Oct. 6, 2005 (DE) 10 2005 048 584.7

(51) Int. Cl. H04L 12/54

(52) U.S. Cl. 370/428

(57) ABSTRACT

A FlexRay communications module for coupling a FlexRay communications link, over which messages are transmitted, to a participant, which is assigned via a participant interface to the FlexRay communications module. To provide a FlexRay communications module which will optimally support the communication processes in a FlexRay network, the FlexRay communications module includes a configuration for storing messages transmitted or to be transmitted between the participant and the FlexRay communications link, and a state machine which, to control the transmission of the messages, specifies and/or invokes sequences relating to information for storing messages in the configuration, for invoking messages from the configuration, and for transmitting the messages.

### FIELD OF THE INVENTION

The present invention relates to a FlexRay communications module for coupling a FlexRay communications link, over which messages are transmitted, to a FlexRay participant, which is assigned via a participant interface to the FlexRay communications module.

The present invention also relates to a method for transmitting messages between a FlexRay participant and a FlexRay communications link, a FlexRay communications module communicating with the communications link, and the participant being connected via a participant interface to the communications module.

Finally, the present invention relates to a FlexRay communications controller having a FlexRay communications module of the type mentioned for implementing the method of the type mentioned.

### BACKGROUND INFORMATION

In recent years, there has been a dramatic increase in the internetworking of control units, sensor systems and actuatorics via a communications system and a bus system, thus a communications link, in the manufacturing of modern motor vehicles and in machine manufacturing, especially in the machine tool sector and in automation processes. In this context, synergistic effects are attainable when functions are distributed among a plurality of control units. One speaks in this case of distributed systems. To an increasing degree, communication among various stations is carried out via a bus system, thus a communications system. The communications traffic on the bus system, access and receiving mechanisms, and error handling are governed by a protocol. A known protocol used for this purpose is the FlexRay protocol, which is presently based on the FlexRay protocol specification v2.0 or v2.1. FlexRay is a rapid, deterministic and fault-tolerant bus system which is especially conceived for use in a motor vehicle. The FlexRay protocol functions in accordance with the time division multiple access (TDMA) principle, the components, thus participants, respectively the messages to be transmitted having fixed time slots allocated thereto, within which they have exclusive access to the communications link. The time slots are repeated in a fixed cycle, making it possible to precisely predict the point in time when a message is transmitted over the bus, and the bus access is executed deterministically. To enable optimal utilization of the bandwidth for transmitting messages on the bus system, FlexRay subdivides the cycle into a static and a dynamic segment. The fixed time slots are located in the static segment at the beginning of a bus cycle. In the dynamic segment, the time slots are allocated dynamically. In this segment, only brief time periods, constituted as so-called minislots, are permitted for each exclusive bus access. Only when a bus access takes place within a minislot is the time slot extended by the requisite time period. Thus, bandwidth is only used when it is also actually needed. In this context, FlexRay communicates over two physically separate lines, each having a maximum data rate of 10 MBit/s. The two channels correspond to the physical layer, in particular of the OSI (open systems interconnection reference model) layer model. They are used primarily for the redundant and thus fault-tolerant transmission of messages, but are also capable of transmitting different types of messages, which would thereby double the data rate. However, FlexRay can also be operated at lower data rates.

To allow implementation of synchronous functions and optimization of the bandwidth through the use of small intervals between two messages, the distributed components in the communications network, thus the participants, require a common time base, the so-called global time. For the nonsynchronization, synchronization messages are transmitted in the static segment of the cycle, a special algorithm being used to correct the local clock time of a component in accordance with the FlexRay specification in such a way that all local clocks run synchronously to a global clock.

A FlexRay network node or FlexRay participant or host includes a participant processor, thus the host processor, a FlexRay controller or communications controller, as well as a bus guardian in the context of a bus monitoring. The host processor, thus the participant processor, delivers and processes the data which are transmitted via the FlexRay communications controller. Messages or message objects may be configured, for instance, for up to 254 data bytes for communication in a FlexRay network.

### SUMMARY

Against this background, example embodiments of the present invention provide a FlexRay communications module which will optimally support the communication processes in a FlexRay network.

Example embodiments of the present invention are characterized in that a message buffer configuration is provided for transmitting the messages between the participant and the communications link, the transmission being controlled by a state machine in such a way that predefinable sequences relating to information for storing and transmitting the messages are specified or retrieved by the state machine.

Within the communications module, the state machine is advantageously hardwired in the hardware and/or the sequences are hardwired in the hardware.

Alternatively, within the FlexRay communications module, the state machine may also be freely programmable by the participant via the participant interface. It is especially beneficial that the information include the access type and/or the access procedure and/or the access address and/or the data size and/or control information pertaining to the data and/or at least one piece of information pertaining to data protection.

These advantages apply to the FlexRay device having a FlexRay communications module for coupling a FlexRay communications link over which messages are transmitted, the device connecting a participant via a participant interface to the communications module, characterized in that a configuration for storing the messages is provided for transmitting the messages between the participant and the communications module, the transmission being controlled by a state machine in such a way that predefinable sequences relating to information for storing and transmitting the messages are specified or retrieved by the state machine.

The advantages apply as well to the method for transmitting messages, a FlexRay communications module being coupled to a FlexRay communications link, over which messages are transmitted, the device connecting a participant via a network participant interface to the communications module, characterized in that the messages are storable in a configuration for storing the messages for transmission thereof between the participant and the communications module, the transmission being controlled by a state machine in such a way that predefinable sequences relating to information for storing and transmitting the messages are specified or retrieved by the state machine.

A FlexRay communications module is advantageously described for coupling a FlexRay communications link as a physical layer to a participant assigned to the FlexRay communications module in a FlexRay network, over which messages are transmitted. The FlexRay communications module advantageously includes a first configuration for storing at least one portion of the transmitted messages and a second configuration for connecting the first configuration to the participant, as well as a third configuration for connecting the FlexRay communications link, thus the physical layer, to the first configuration.

In this context, the first configuration advantageously includes a message handler and a message memory, the message handler assuming the control of the data paths of the first and second configuration in terms of a data access to the message memory. The message memory of the first configuration is advantageously divided into a header segment and a data segment.

To access the host, thus the FlexRay participant or the host processor, the second configuration advantageously has an input buffer and an output buffer, in an example embodiment, either the input buffer or the output buffer or preferably both buffers being subdivided into a partial buffer and a shadow memory, which are alternately only read and/or written at any one time, thereby ensuring the data integrity. The alternate reading or writing of the particular partial buffer and corresponding shadow memory may be advantageously achieved by interchanging the particular access or by interchanging the memory contents.

It is beneficial in this context when each partial buffer and each shadow memory are configured to allow storage of one data area and/or one header area of two FlexRay messages.

To allow easier adaptation to various participants or hosts, the second configuration includes an interface module, composed of a participant-specific submodule and a participant-independent submodule, so that adaptation to a participant merely requires modifying the participant-specific submodule, thereby altogether enhancing the flexibility of the FlexRay communications module. In this context, the submodules may also be implemented within the one interface module as software, thus each submodule as a software function.

In accordance with the redundant transmission paths characteristic of FlexRay, the third configuration advantageously includes a first interface module and a second interface module and is subdivided, in turn, into two data paths, each having two data directions. The third configuration also advantageously includes a first and a second buffer, in order to accommodate the two data paths and the respective two data directions. In this case as well, the first and second buffer are configured to allow storage of at least one data area of each of two FlexRay messages. Each interface module of the third configuration advantageously includes a shift register and a FlexRay protocol state machine.

The FlexRay communications module according to example embodiments of the present invention is able to fully support the FlexRay protocol specification, in particular v2.0 or v2.1, so that up to 128 messages or message objects may be configured, for instance. The result is a flexibly configurable message memory for storing a different number of message objects as a function of the size of the respective data field or data area of the message. Thus, messages or message objects having data fields of different lengths are advantageously configurable. In this context, the message memory is advantageously set up as a FIFO (first-in first-out) memory, so that a configurable receive FIFO is provided. Each message, respectively each message object in the memory may be configured as a receive buffer object (receive buffer), transmit buffer object (transmit buffer), or as a part of the configurable receive FIFO. Likewise possible is an acceptance filtering of frame ID, channel ID and cycle counter within the FlexRay network. Thus, the network management is expediently supported. Moreover, maskable module interrupts are advantageously provided.

Other advantages and advantageous embodiments are further described below.

Example embodiments of the present invention are explained in greater detail with reference to the following figures of the drawing.

### BRIEF DESCRIPTION OF THE DRAWINGS

FIG. 1 in a schematic representation, the communications module and connection thereof to the physical layer, thus the communications link and the communications or host participant;

FIG. 2 an example embodiment of the communications module from FIG. 1, as well as connection thereof, in detail;

FIG. 3 the structure of a message memory of the communications module according to FIG. 1 or 2;

FIG. 4 to 6 a schematic view of the architecture and of the process of the data access in the direction from the participant to the message memory of the communications module;

FIG. 7 to 9 a schematic view of the architecture and of the process of the data access in the direction from the message memory of the communications module to the participant;

FIG. 10 a schematic representation of a message handler of the communications module, and of the finite state machines contained therein;

FIG. 11 again, schematically, the components of the communications module, as well as the participant, and the corresponding data paths controlled by the message handler;

FIG. 12 the access distribution with respect to the data paths in FIG. 11;

FIG. 13 a simplified implementation of the participant interface between the communications module and the participant;

FIG. 14 a state machine according to an example embodiment of the present invention mapped in a flow chart;

FIG. 15 the states of the state machine according to FIG. 14 for a specific buffer access.

### DETAILED DESCRIPTION

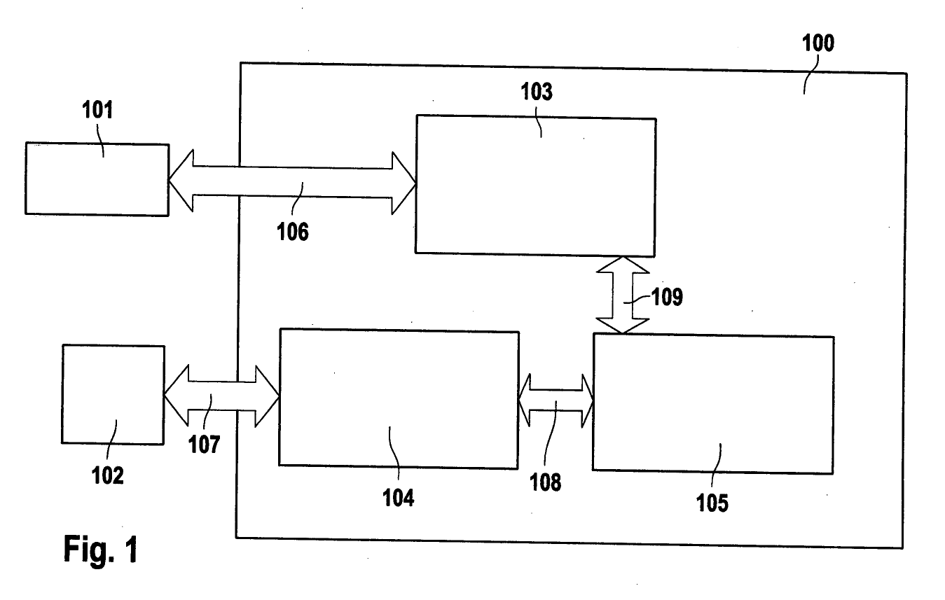

FIG. 1 schematically shows a FlexRay communications module 100 for connecting a participant or host 102 to a FlexRay communications link 101, thus the physical layer of the FlexRay. To that end, FlexRay communications module 100 is connected via a connection 107 to the participant or participant processor 102, and via a connection 106 to communications link 101. In terms of a problem-free connection with respect to transmission times, on the one hand, and with respect to data integrity, on the other hand, substantially three configurations are schematically differentiated within the FlexRay communications module. A first configuration 105 is used for storage, in particular in the manner of a clipboard, of at least a portion of the messages to be transmitted. Between participant 102 and this first configuration 105, a second configuration 104 is connected via connections 107 and 108. In the same way, a third configuration 103 is connected via connections 106 and 109 between participant 101 and first configuration 105, a very flexible inputting and outputting of data as part of messages, in particular FlexRay messages, into and out of first configuration 105 being thereby attainable at optimal speed, while ensuring data integrity.

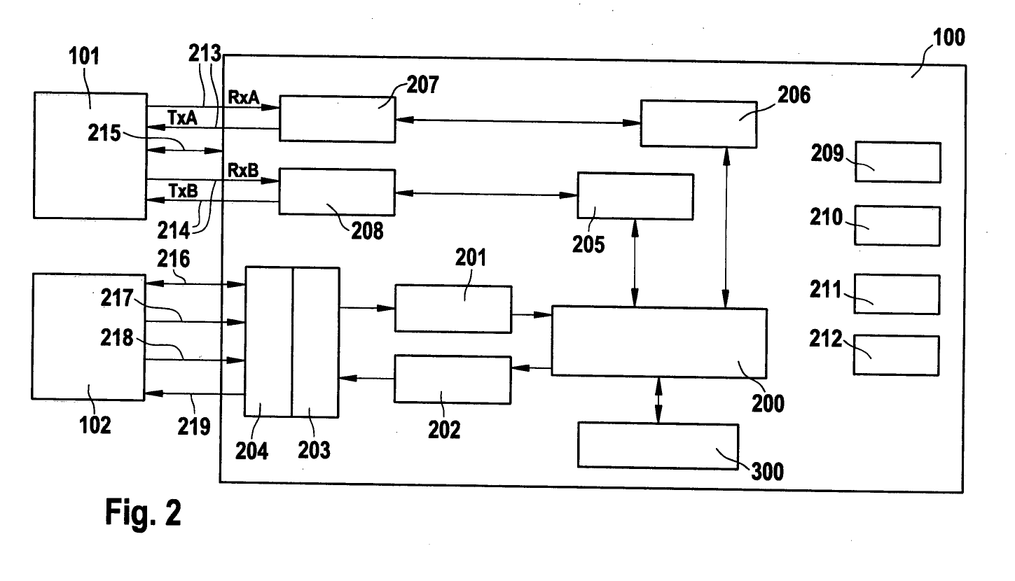

This communications module 100 is shown again in greater detail in FIG. 2, in an example embodiment. Also shown in greater detail are connections 106 through 109 in question. Second configuration 104 includes an input buffer (IBF) 201, an output buffer (OBF) 202, as well as an interface module composed of two parts 203 and 204, the one submodule 203 being participant-independent and second submodule 204 being participant-specific. Participant-specific submodule 204 (customer CPU interface CIF) connects a participant-specific host CPU 102, thus a customer-specific participant, to FlexRay communications module 100. To that end, a bidirectional data line 216, an address line 217, as well as a control input 218 are provided. An interrupt output denoted by 219 is likewise provided. Participant-specific submodule 204 communicates with a participant-independent submodule 203 (generic CPU interface, GIF), i.e., the FlexRay communications module, also termed FlexRay IP module, has a generic, thus general CPU interface, to which a large number of different customer-specific host CPUs are connectable via corresponding participant-specific submodules, thus customer CPU interfaces CIF. Thus, it is merely necessary to vary submodule 204 as a function of the participant, signifying a substantially lower outlay.

Input buffer 201 and output buffer 202 may be configured in one memory module, or else in separate memory modules. In this context, input buffer 201 is used for buffer storing messages for transmission to message memory 200. The input buffer module is preferably designed for storing two complete messages composed of one header segment, in particular having configuration data, and one data segment or payload segment. The input buffer has a two-part design (partial buffer and shadow memory), which permits acceleration of the transmission between participant CPU 102 and message memory 200 by alternately writing the two parts of the input buffer, i.e., by alternating access thereto. In the same manner, the output buffer OBF for 30 is used for buffer storing messages for transmission from message memory 200 to participant CPU 102. Output buffer 202 is also designed for storing two complete messages composed of a header segment, in particular having configuration data, and of a data segment, thus payload segment. In this case as well, output buffer 202 is subdivided into two parts, a partial buffer and a shadow memory, likewise permitting acceleration of the transmission between participant CPU or host CPU 102 and message memory 200 by alternately reading the two parts, i.e., by alternating access thereto. This second configuration 104, composed of blocks 201 through 204, is connected to first configuration 105, as shown.

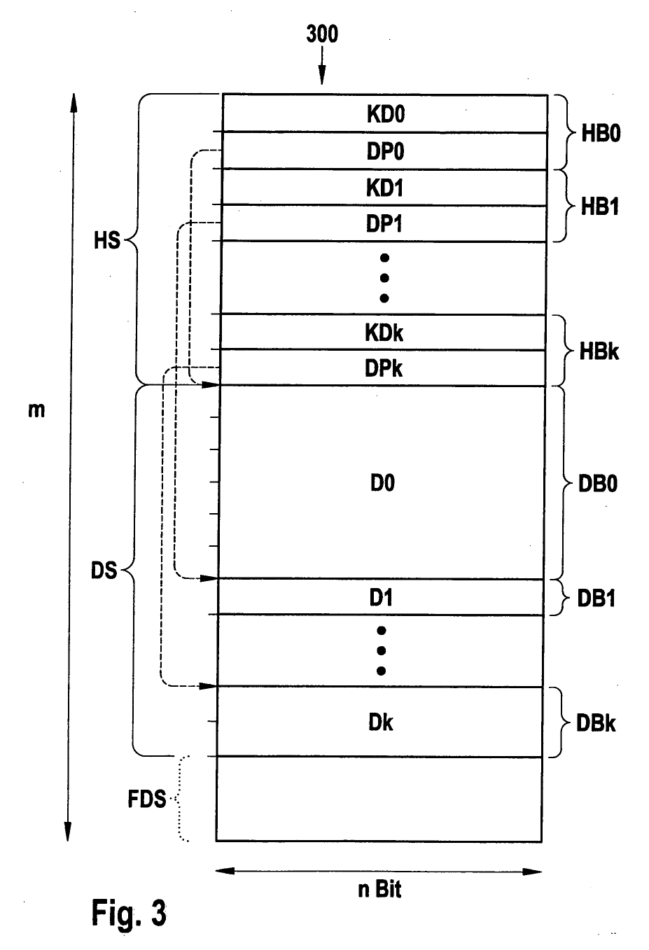

Configuration 105 is composed of a message handler (MHD) 200 and a message memory 300 (message RAM). The message handler controls the data transfer between input buffer 201, as well as output buffer 202 and message memory 300. It likewise controls the data transfer in the other direction via third configuration 103. The message memory is preferably designed as a single-ported RAM. This RAM memory stores the messages or message objects, thus the actual data, together with configuration and status data. The precise structure of message memory 300 is shown in greater detail in FIG. 3.

Third configuration 103 is composed of blocks 205 through 208. In accordance with the two channels characteristic of the FlexRay physical layer, this configuration 103 is subdivided into two data paths, each having two data directions. This is clearly shown by connections 213 and 214, in which the two data directions for channel A, RxA and TxA for reception (RxA) and transmission (TxA), as well as for channel B, RxB and TxB are illustrated. Connection 215 denotes an optional bidirectional control input. Third configuration 103 is connected via a first buffer 205 for channel B and a second buffer 206 for channel A. These two buffers (transient buffer RAMs: RAM A and RAM B) are used as buffer memories for the data transmission from and, respectively, to first configuration 105. In conformance with the two channels, these two buffers 205 and 206 are each connected to one interface module 207 and 208, which contain the FlexRay protocol controllers or bus protocol controllers, composed of a transmit/receive shift register and of the FlexRay protocol finite state machine. Thus, the two buffers 205 and 206 are used as buffer memories for the data transmission between the shift registers of the interface modules or FlexRay protocol controllers 207 and 208 and message memory 300. Here as well, each buffer 205 or 206 advantageously stores the data fields, thus the payload segment or data segment of two FlexRay messages.

Also illustrated within communications module 100 is the global time unit (GTU), designated by 209, which is responsible for representing the global time base within FlexRay, i.e., microtick μT and macrotick MT. Global time unit 209 is likewise used as a basis for regulating the fault-tolerant clock synchronization of the cycle counters and the control of the time sequences in the static and dynamic segment of the FlexRay. Block 210 represents the general system control (system universal control SUC) which checks and controls the operational modes of the FlexRay communications controller. These include wake-up, startup, reintegration or integration, normal operation and passive operation.

Block 211 represents the network and error management (NEM), as described in the FlexRay protocol specification v2.0. Finally, block 212 represents the interrupt control (INT), which manages the status and error interrupt flags and checks or controls the interrupt outputs 219 to participant CPU 102. Moreover, block 212 includes an absolute and a relative timer for producing timer interrupts.

Message objects or messages (message buffer) may be configured with up to 254 data bytes for the communication within a FlexRay network. Message memory 300 is, in particular, a message RAM which is capable of storing up to a maximum of 128 message objects, for example. All functions which relate to the handling or management of the messages themselves are implemented in message handler 200. These include, for example, acceptance filtering, transfer of messages between the two FlexRay protocol controller blocks 207 and 208 and message memory 300, i.e., the message RAM, as well as controlling the transmit sequence and supplying configuration data and status data, respectively.

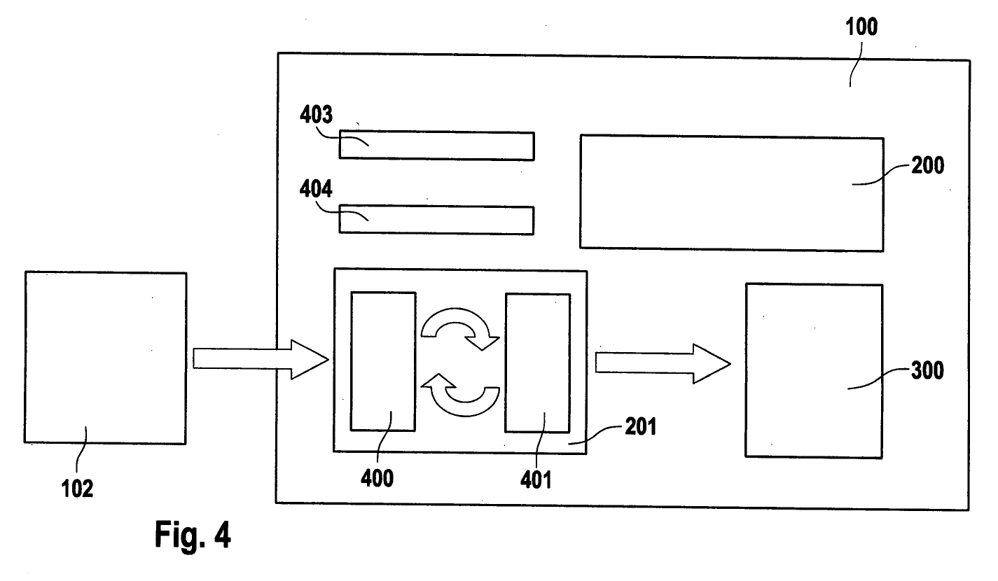

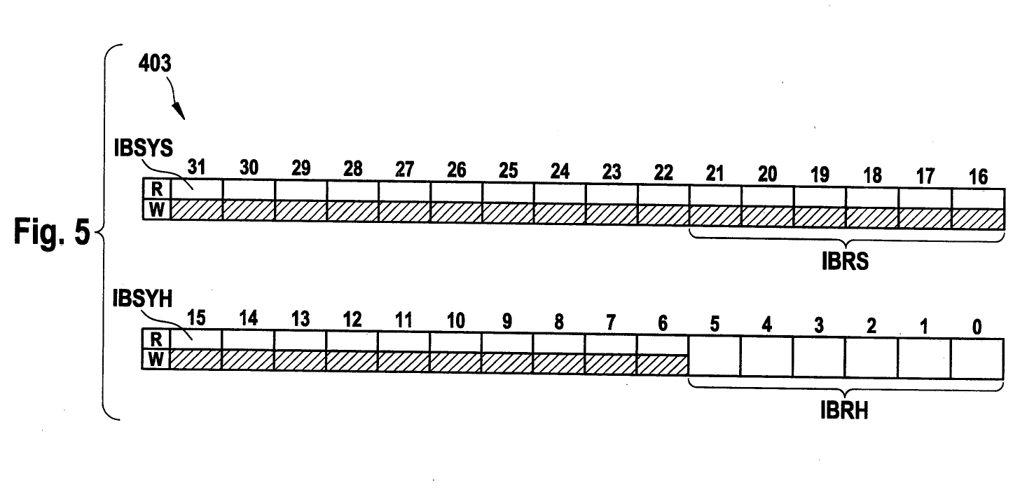

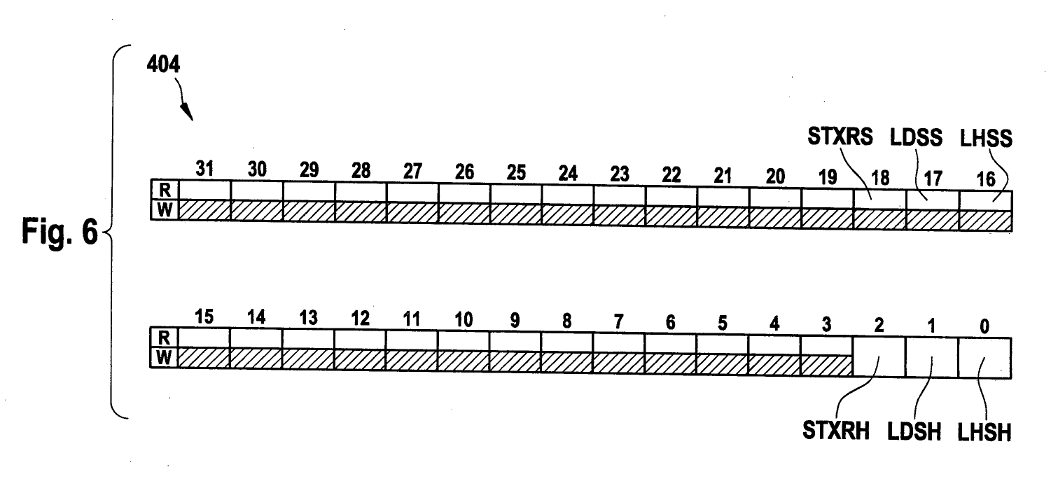

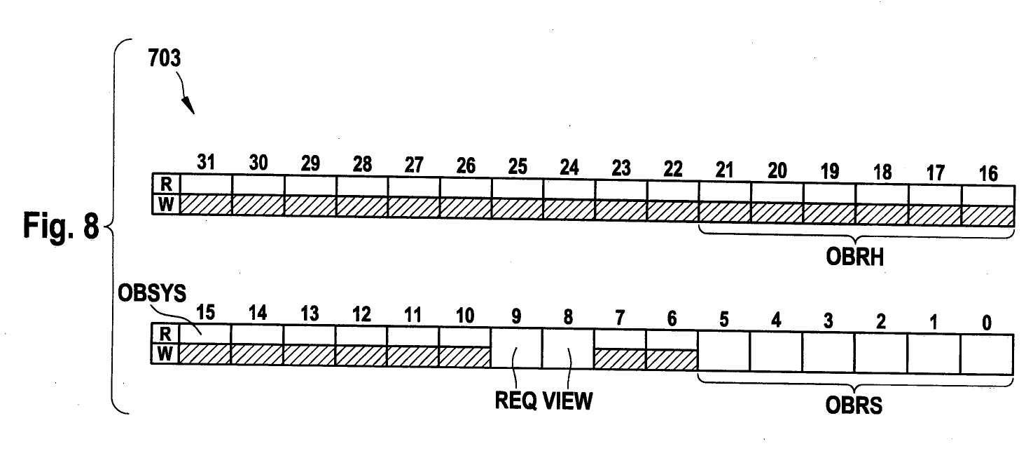

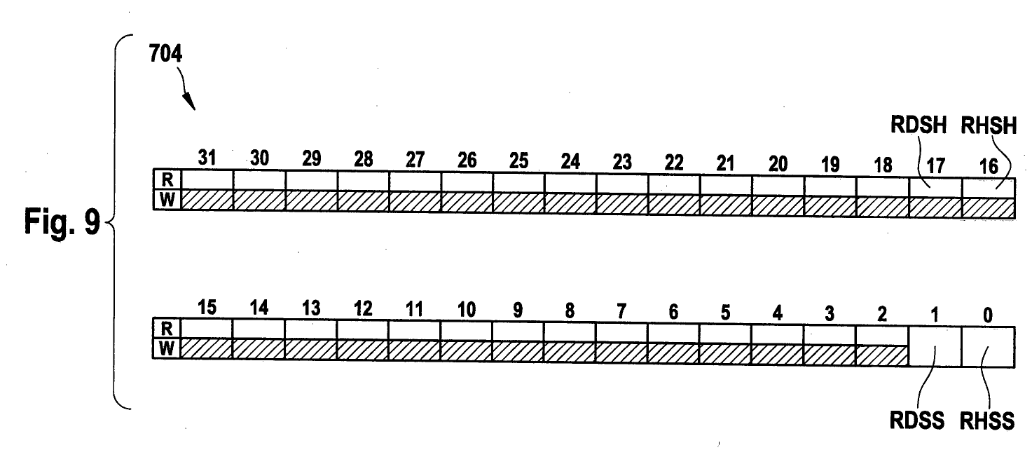

An external CPU, thus an external processor, participant processor 102, may directly access the register of the FlexRay communications module via the participant interface, using participant-specific part 204. In this context, a multiplicity of registers is used. These registers are used to configure and control the FlexRay protocol controller, thus interface modules 207 and 208, message handler (MHD) 200, global time unit (GTU) 209, system universal controller (SUC) 210, network and error management unit (NEM) 211, interrupt controller (INT) 212, as well as the access to the message RAM, thus message memory 300, and to indicate the corresponding status, as well. At least parts of these registers are described in greater detail in FIG. 4 through 6 and 7 through 9. A FlexRay communications module in accordance with example embodiments of the present invention of the type described makes it possible for FlexRay specification v2.0 or v2.1 to be simply realized, allowing an ASIC or a microcontroller having corresponding FlexRay functionality to be generated in a simple manner.

The partitioning of message memory 300 is shown in detail in FIG. 3. The functionality of a FlexRay communications controller as required by the FlexRay protocol specification necessitates a message memory for supplying messages to be transmitted (transmit buffer), as well as for storing messages received without error (receive buffer). A FlexRay protocol permits messages having a data area, thus a payload, of 0 to 254 bytes. As shown in FIG. 2, the message memory is part of FlexRay communications module 100. The following describes the method, as well as the corresponding message memory for storing messages to be transmitted, as well as received messages, in particular through the use of a random access memory (RAM), the mechanism according to example embodiments of the present invention making it possible to store a variable number of messages in a message memory of a specified size. The number of messages able to be stored is a function of the size of the data areas of the individual messages, which means, first of all, it is possible to minimize the size of the memory needed without limiting the size of the data areas of the messages, and secondly, the memory is optimally utilized. This variable partitioning of an, in particular, RAM-based message memory for a FlexRay communications controller is described in greater detail below.

For the implementation, a message memory having a defined word length of n bits, for example 8, 16, 32, etc., as well as a specified memory depth of m words (m, n as natural numbers) is presented exemplarily. In this instance, message memory 300 is partitioned into two segments, a header segment HS and a data segment DS (payload section, payload segment). Thus, one header area HB and one data area DB are created per message. Thus, for messages 0, 1 through k (k as natural number), header areas HB0, HB1 through HBk and data areas DB0, DB1 through DBk are created. Thus, in one message, the distinction is made between first and second data, the first data corresponding to configuration data and/or status data relating to the FlexRay message, and being stored in each instance in a header area HB (HB0, HB1, . . . , HBk). The second data, which correspond to the actual data that are to be transmitted, are stored accordingly in data areas DB (DB0, DB1, . . . , DBk). Thus, a first data volume (measured in bits, bytes or memory words) is obtained per message for the first data, and a second data volume (likewise measured in bits, bytes or memory words) is obtained for the second data of a message, in which case the second data volume may vary per message. Thus the partition between header segment HS and data segment DS is variable within message memory 300, i.e., there is no specified boundary between the areas. In accordance with the present invention, the partition between header segment HS and data segment DS is a function of the number k of messages, as well as of the second data volume, thus the volume of the actual data, of one message or of all k messages together. The present invention also provides for a data pointer DP0, DP1 through DPk to be directly assigned to the configuration data KD0, KD1 through KDk of the particular message. In an example embodiment, a fixed number of memory words, in this case two, is assigned to each header area HB0, HB1 through HBk, so that one configuration datum KD (KD0, KD1, . . . , KDk) and one data pointer DP (DP0, DP1, . . . , DPk) are stored together in one header area HB. This header segment HS having header areas HB, whose size or first data volume is a function of number k of the messages to be stored, is followed by data segment DS for storing actual message data D0, D1 through Dk. With respect to its data volume, this data segment (or data section) DS is dependent on the stored message data, in this case, for example, six words in DB0, one word in DB1, and two words in DBk 30. Thus, data pointers DP0, DP1 through DPk in question always point to the beginning, thus to the start address of respective data area DB0, DB1 through DBk in which data D0, D1 through Dk of respective messages 0, 1 through k are stored. Therefore, the partitioning of the message memory between header segment HS and data segment DS is variable and is a function of the number of messages themselves, as well as of the particular data volume of one message, and thus of the entire second data volume. If fewer messages are configured, the header segment becomes smaller and the area in the message memory that is becoming available may be used to supplement data segment DS for storing data. This variability makes it possible to ensure optimal memory utilization, thereby permitting the use of smaller memories as well. Thus, available data segment FDS, particularly the size thereof, which is likewise a function of the combination of number k of stored messages and the particular second data volume of the messages, is therefore minimal and may even become 0.

Besides the use of data pointers, it is also possible to store the first and second data, thus configuration data KD (KD0, KD1, . . . , KDk) and actual data D (D0, D1, . . . , Dk) in a predefinable sequence, so that the sequence of header areas HBO through HBk in header segment HS and the sequence of data areas DB0 through DBk in data segment DS are identical in each instance. In that case, the need for a pointer element could possibly even be eliminated.

In an example embodiment, the message memory is assigned an error-identifier generator, particularly a parity bit generator element, and an error-identifier checker, in particular a parity bit check element, to ensure the correctness of the stored data in HS and DS, in that one checksum may be co-stored, especially as a parity bit, per memory word or per area (HB and/or DB). Other check identifiers, such as a CRC (cyclic redundancy check), or even higher-level identifiers, such as ECC (error code correction), are possible. Thus, in comparison to a fixed partitioning of the message memory, the following advantages are derived:

When programming, the user may decide whether he/she would like to use a larger number of messages having a small data field or a smaller number of messages having a large data field. The available memory capacity may be optimally utilized when configuring messages having different-sized data areas. The user has the option of making joint use of one data memory area for different messages.

When the communications controller is implemented on an integrated circuit, the size of the message memory may be adjusted by adapting the memory depth of the memory used to the particular requirements of the application, without altering the other functions of the communications controller.

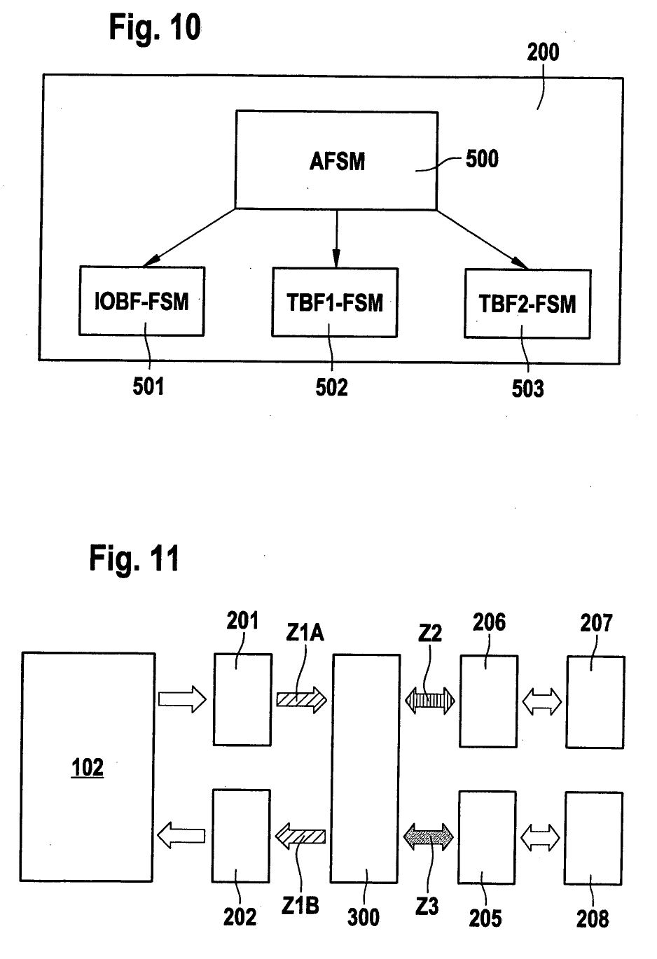

A more detailed description of the host CPU access, thus of the writing and reading of configuration data and status data, respectively, and the actual data via buffer configuration 201 and 202, is provided in the following, with reference to FIG. 4 through 6 and 7 through 9. The aim in this context is to provide a decoupling of the data transmission in a way that will allow the data integrity to be safeguarded and, at the same time, a high transmission rate to be ensured. These processes are controlled via message handler 200, as is described in greater detail further below with reference to FIGS. 10, 11 and 12.

To begin with, FIGS. 4, 5 and 6 illustrate in greater detail the write accesses to message memory 300 by the host CPU of participant CPU 102, via input buffer 201. To that end, FIG. 4 once again shows communications module 100, for the sake of clarity, only those parts of communications module 100 which are relevant here being shown. In the first instance, they include message handler 200, which is responsible for controlling the operational sequences, as well as two control registers 403 and 404 which, as shown, may be accommodated outside of message handler 200 within communications module 100, but may also be contained within message handler 200 itself. In this context, 403 represents the input buffer command request register, and 404 represents the input buffer command mask register. Thus, write accesses by host CPU 102 to message memory 300 (message RAM) take place via an interposed input buffer 201. This input buffer 201 has a split or double design, namely as a partial buffer 400 and a shadow memory 401 belonging to the partial buffer. This allows host CPU 102 to continuously access the messages or message objects, respectively data of message memory 300, as described in the following, making it possible to ensure data integrity and accelerated transmission. The accesses are controlled via input buffer command request register 403 and via input buffer command mask register 404. Numbers 0 through 31 represent the respective bit positions in register 403 exemplarily for a width of 32 bits. The same holds for register 404 and bit positions 0 through 31 in 404.

Bit positions 0 through 5, 15, 16 through 21 and 31 of register 403 have been assigned a special function with regard to the sequence control exemplarily and in accordance with an example embodiment the present invention. Thus, an identifier IBRH (input buffer request host) may be entered as a message identifier into bit positions 0 through 5 of register 403. In the same way, an identifier IBRS (input buffer request shadow) may be entered into bit positions 16 through 21 of register 403. Likewise entered as access identifiers are IBSYH into register position 15 of 403, and IBSYS into register position 31 of 403. Also specially marked are positions 0 through 2 of register 404, other identifiers being entered as data identifiers in 0 and 1 as LHSH (load header section host) and LDSH (load data section host). These data identifiers are in the simplest form here, namely each is constituted of one bit. A start identifier is written as STXRH (set transmission X request host) into bit position 2 of register 404. The sequence of the write access to the message memory via the input buffer is described in the following.

Host CPU 102 writes the data of the message to be transferred into input buffer 201. In the process, host CPU 102 is only able to write configuration data and header data KD of a message for the header segment HS of the message memory or only the actual data D to be transmitted of a message for data segment DS of the message memory, or both. Which part of a message, thus, configuration data and/or the actual data, is to be transmitted is stipulated by special data identifiers LHSH and LDSH in input buffer command mask register 404. In this context, LHSH (load header section host) determines whether the header data, thus configuration data KD, are to be transmitted, and LDSH (load data section host) determines whether data D are to be transmitted. Due to the fact that input buffer 201 has a two-part design made up of partial buffer 400 as one part and shadow memory 401 corresponding thereto, and access is to take place in an alternating process, two further data-identifier areas, which at this point are specific to shadow memory 401, are provided as counterpart to LHSH and LDSH. These data identifiers in bit positions 16 and 17 of register 404 are denoted by LHSS (load header section shadow) and LDSS (load data section shadow). Thus, they control the transmission process with respect to shadow memory 401.

If, at this point, the start bit or start identifier STXRH (set transmission X request host) is set in bit position 2 of input buffer command mask register 404, then, once the configuration data and/or actual data to be transmitted have been transferred into message memory 300, a transmission request is automatically set for the message object in question. This means that the process of automatically transmitting a message object to be transmitted is controlled, in particular started by this start identifier STXRH.

The counterpart corresponding thereto for the shadow memory is start identifier STXRS (set transmission X request shadow) which, for example, is contained in bit position 18 of input buffer command mask register 404, and, here as well, is likewise constituted as one bit in the simplest case. The function of STXRS is analogous to that of STXRH, but is merely specific to shadow memory 1.

When host CPU 102 writes the message identifier, in particular the number of the message object in message memory 300, into which the data of input buffer 201 are to be transferred, into bit positions 0 through 5 of input buffer command request register 403, thus according to IBRF-I, partial buffer 400 of input buffer 201 and corresponding shadow memory 401 are interchanged, respectively the particular access by host CPU 102 and message memory 300 to the two partial buffers 400 and 401 is interchanged, as indicated by the semicircular arrows. In the process, the data transfer, thus the data transmission to message memory 300 is also started, for example. The data transmission to message memory 300 itself takes place from shadow memory 401. At the same time, register areas IBRH and IBRS are exchanged. LHSH and LDSH are likewise exchanged for LHSS and LDSS. STXRH is likewise exchanged with STXRS. Therefore, IBRS indicates the identifier of the message, thus the number of the message object for which a transmission, thus a transfer from shadow memory 401 is in progress, respectively which message object, thus which area in the message memory was the most recent to receive data (KD and/or D) from shadow memory 401. The identifier (here again, for example, 1 bit) IBSYS (input buffer busy shadow) in bit position 31 of input buffer command request register 403 provides indication of whether a transmission is currently in progress, with the participation of shadow memory 401. Thus, for example, when IBSYS=1, a transmission is currently in progress from shadow memory 401, and when IBSYS=0, it is not. This bit IBSYS is set, for example, by the writing of IBRH, thus in bit positions 0 through 5 in register 403, to indicate that a transfer between shadow memory 401 and message memory 300 is in progress. Once this data transmission to message memory 300 has ended, IBSYS is reset again.

Right during the data transfer from shadow memory 401, host CPU 102 may write the next message to be transferred into the input buffer, respectively into partial buffer 400. The identifier may be refined still further by using an additional access identifier IBSYH (input buffer busy host), for example in bit position 15 of register 403. If host CPU 102 writes IBRH, thus bit positions 0 through 5 of register 403, right when a transmission between shadow memory 401 and message memory 300 is in progress, thus when IBSYS=1, then IBSYH is set in input buffer command request register 403. Upon conclusion of the active transfer, thus of the active transmission in progress, the requested transfer (request through STXRH, see above) is started, and bit IBSYH is reset. Bit IBSYS remains set for the entire time in order to indicate that data are being transferred to the message memory. All of the bits used in all of the exemplary embodiments may also be constituted as identifiers having more than one bit. A one-bit approach is advantageous from a standpoint of memory and processing efficiency.

The thus described mechanism makes it possible for host CPU 102 to continually transfer data into the message objects that are located in the message memory and composed of header area HB and data area DB, provided that the access speed of host CPU 102 to the input buffer is less than or equal to the internal data-transfer rate of the FlexRay IP module, thus of communications module 100.

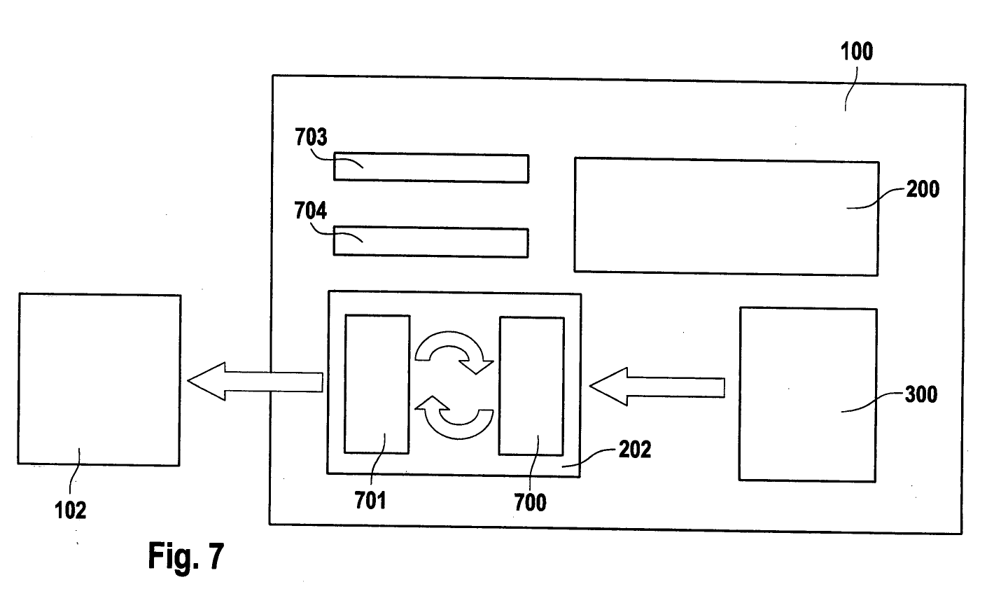

The read accesses to message memory 300 by host CPU or participant CPU 102 via output buffer 202 are illustrated in greater detail in FIGS. 7, 8 and 9. To that end, FIG. 7 once again shows communications module 100, for the sake of clarity, only those parts of communications module 100 which are relevant here being shown. In the first instance, they include message handler 200, which is responsible for controlling the operational sequences, as well as two control registers 703 and 704 which, as shown, may be accommodated outside of message handler 300 within communications module 100, but may also be contained within message handler 200 itself. In this context, 703 represents the output buffer command request register, and 704 the output buffer command mask register. Thus, read accesses by host CPU 102 to message memory 300 take place via interposed output buffer 202. This output buffer 202 likewise has a split or double design, namely as a partial buffer 701 and a shadow memory 700 belonging to the partial buffer. This allows host CPU 102 to continuously access the messages or message objects, respectively data of message memory 300, as described in the following, making it possible to ensure data integrity and accelerated transmission in the reverse direction from message memory to the host. The accesses are controlled via output buffer command request register 703 and via input buffer command mask register 704. Numbers 0 through 31 represent the respective bit positions in register 703 exemplarily for a width of 32 bits. The same holds for register 704 and bit positions 0 through 31 in 704.

Bit positions 0 through 5, 8 and 9, 15 and 16 through 21 of register 703 have been assigned a special function with regard to the sequence control of the read access exemplarily and in accordance with example embodiments of the present invention. Thus, an identifier OBRS (output buffer request shadow) may be entered as a message identifier into bit positions 0 through 5 of register 703. In the same way, an identifier OBRH (output buffer request host) may be entered into bit positions 16 through 21 of register 703. An identifier OBSYS (output buffer busy shadow) may be entered as access identifier into bit position 15 of register 703. Also specially marked are positions 0 and 1 of output buffer command mask register 704, other identifiers being entered as data identifiers in bit positions 0 and 1 as RDSS (read data section shadow) and RHSS (read header section shadow). Additional data identifiers are provided, for example, in bit positions 16 and 17 as RDSH (read data section host) and RHSH (read header section host). These data identifiers are also are in the simplest form here by way of example, namely each is constituted of one bit. A start identifier REQ is entered into bit position 9 of register 703. A changeover identifier VIEW is also provided, which is entered exemplarily into bit position 8 of register 703.

Host CPU 102 requests the data of a message object from message memory 300 by writing the identifier of the desired message, thus, in particular, the number of the desired message object, according to OBRS, thus into bit positions 0 through 5 of register 703. As in the case of the reverse direction, the host CPU may also either read only the status or configuration data and header data KD of a message, thus from a header area, or may only read data D of a message actually to be transmitted, thus from the data area, or also both. The portion of the data that is to be transmitted from the header area and/or data area is determined in this instance by RHSS and RDSS, in a manner comparable to that of the reverse direction. This means that RHSS indicates whether the header data are to be read, and RDSS indicates whether the actual data are to be read.

A start identifier is used for the purpose of starting the transmission from the message memory to shadow memory 700. This means that if a bit is used as an identifier, as in the simplest case, the transmission from message memory 300 to shadow memory 700 is started by setting bit REQ in bit position 9 in output buffer command request register 703. The active transmission in progress is again indicated by an access identifier, here again in the simplest case by one bit OBSYS in register 703. In order to avoid collisions, it is beneficial when bit REQ is only able to be set when OBSYS is not set, thus when there is no active transmission currently in progress. The message transfer between message memory 300 and shadow memory 700 takes place then in this instance as well. At this point, the actual sequence could be controlled and carried out in a manner comparable to that of the reverse direction, as described under FIGS. 4, 5 and 6 (complementary register assignment), or, however, in a variation, using an additional identifier, namely a changeover identifier VIEW in bit position 8 of register 703. This means that, upon completion of the transmission, the OBSYS bit is reset, and, by setting the VIEW bit in output buffer command request register 703, partial buffer 701 and corresponding shadow memory 700 are exchanged, i.e., the accesses thereto are exchanged, and host CPU 102 is able to read the message object requested by message memory, thus the corresponding message from partial buffer 701. In the process, register cells OBRS and OBRH are exchanged in this case as well, in a manner comparable to that of the reverse transmission direction in FIG. 4 through 6. RHSS and RDSS are likewise exchanged for RHSH and RDSH. As a protective mechanism, it may also be provided in this case for the VIEW bit to only be set when OBSYS is not set, thus when no active transmission is currently in progress.

Thus, read accesses by host CPU 102 to message memory 300 are carried out via an interposed output buffer 202. This output buffer has a split or double design similarly to the input buffer, in order to ensure a continuous access by host CPU 102 to the message objects which are stored in message memory 300. The advantages of high data integrity and accelerated transmission are accomplished in this case as well.

The use of the described input and output buffers ensures that a host CPU is able to access the message memory without interruption, in spite of the latency times internal to the module.

To safeguard this data integrity, the data transmission, in particular the routing within communications module 100, is undertaken by message handler (MHD) 200. To that end, message handler 200 is shown in FIG. 10. With respect to its functionality, the message handler may be described as a plurality of state machines or finite automata, so-called finite state machines (FSM). At least three finite state machines are provided in this instance, and four finite state machines are provided in an example embodiment. A first finite state machine is the IOBF-FSM (input/output buffer state machine), designated by 501. Depending on the transmission direction with respect to the input buffer or the output buffer, this IOBF-FSM could also be split into two finite state machines, IBF-FSM (input buffer FSM) and OBF-FSM (output buffer FSM), a maximum of five finite automata (IBF-FSM, OBF-FSM, TBF1-FSM, TBF2-FSM, AFSM) being possible. It is preferable, however, to provide one shared IOBF-FSM. In the context of an exemplary embodiment, at least one second finite state machine is split into two blocks 502 and 503, and controls the operation of the two channels A and B with respect to buffers 205 and 206, as described with reference to FIG. 2. Provision may be made for one finite state machine to control the operation of both channels A and B or, however, as in the preferred form, one finite state machine TBF1-FSM denoted by 502 (transient buffer 1 (206, RAM A) state machine) for channel A, and one TBF2-FSM denoted by 503 (transient buffer 2 (205, RAM B) state machine) for channel B.

In an exemplary embodiment, an arbiter finite state machine, the so-called AFSM, denoted by 500, is used to control the access by the three finite state machines 501-503. The data (KD and/or D) are transmitted in the communications module at a clock pulse that is generated by a clock generator device, such as a VCO (voltage controlled oscillator), for example, a quartz oscillator, etc., or that is adapted therefrom. Clock pulse T may be generated within the module or be externally input, for example as a bus clock pulse. This arbiter finite state machine AFSM 500 alternately grants one of the three finite state machines 501-503 access to the message memory, in particular for one clock pulse period T at a time. This means that the available time is divided among these requesting finite automata in accordance with the access requests made by the individual finite automata 501, 502, 503. If an access request is made by only one finite state machine, then it receives 100% of the access time, thus all clock pulse periods T. If an access request is made by two finite automata, then each finite state machine is granted 50% of the access time. Finally, if an access request is made by three finite automata, then each of the finite state machines is granted ⅓ of the access time. As a result, the bandwidth available in each case is optimally utilized.

First finite state machine is denoted by 501, thus IOBF-FSM executes the following actions, as needed:

data transfer from input buffer 201 to the selected message object in message memory 300;

data transfer from the selected message object in message memory 300 to output buffer 202.

The state machine for channel A 502, thus TBF1FSM, executes the following actions:

data transfer from the selected message object in message memory 300 to buffer 206 of channel A;

data transfer from buffer 206 to the selected message object in message memory 300;

search for the matching message object in the message memory, during reception, the message object (receive buffer) is searched for in the course of an acceptance filtering, in order to store a message received on channel A, and, during transmission, the next message object (transmit buffer) to be transmitted on channel A.

The action of TBF2-FSM, thus of the finite state machine for channel B in block 503 is analogous thereto. It executes the data transfer from the selected message object in message memory 300 to buffer 205 of channel B and the data transfer from buffer 205 to the selected message object in message memory 300. The search function for a matching message object in the message memory is also analogous to TBF1-FSM, during reception, the message object (receive buffer) being searched for in the course of an acceptance filtering, in order to store a message received on channel B, and, during transmission, the next message object (transmit buffer) to be transmitted on channel B.

The operational sequences and the transmission paths are illustrated again in FIG. 11. The three finite state machines 501-503 control the respective data transmissions among the individual parts. The host CPU is again represented by 102, the input buffer by 201, and the output buffer by 202. The message memory is denoted by 300, and the two buffers for channel A and channel B by 206 and 205. Interface elements 207 and 208 are likewise represented. First finite automaton IOBF-FSM, denoted by 501, controls data transfer Z1A and Z1B, thus from input buffer 201 to message memory 300 and from message memory 300 to output buffer 202. The data transmission takes place via data buses having a word length of 32 bits, for example, any other bit number being possible. The same holds for transmission Z2 between the message memory and buffer 206. This data transmission is controlled by TBFI-FSM, thus 502, the state machine for channel A. Transmission Z3 between message memory 300 and buffer 205 is controlled by finite-state automaton TBF2-FSM, thus 503. Here, as well, the data transfer takes place via data buses having an exemplary word length of 32 bits, any other bit number likewise being possible. Normally, the transfer of one complete message object over the transmission paths mentioned requires a plurality of clock pulse periods T. For that reason, the arbiter, thus AFSM 500, allocates the transmission time relative to clock pulse periods T. Thus, FIG. 11 shows the data paths between the buffer components controlled by message handler 200. To safeguard the data integrity of the message objects stored in the message memory, data should be advantageously exchanged simultaneously on only one of the paths shown, thus on Z1A and Z1B, as well as Z2 and Z3.

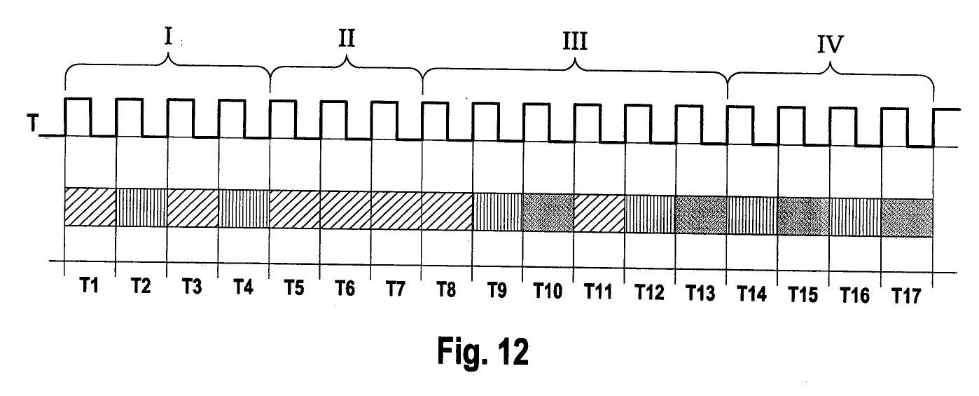

With reference to an example, FIG. 12 shows how the available system clock pulses T are allocated by the arbiter, thus by AFSM 500, among the three requesting finite-state automata. In phase 1, access requests are made by finite-state automaton 501 and finite-state automaton 502, i.e., one half of the entire time is allocated to each of the two requesting finite-state automata. In terms of the clock pulse periods in phase 1, this means that finite-state automaton 501 is granted access in clock pulse periods T1 and T3, and finite-state automaton 502 in clock pulse periods T2 and T4. In phase 2, access is made only by state machine 501, so that all three clock pulse periods, thus 100% of the access time from T5 through T7, is allotted to IOBF-FSM. In phase 3, access requests are made by all three finite-state automata 501 through 503, so that the total access time is divided into thirds.

Arbiter AFSM then allocates the access time in such a way, for example, that access is granted to finite state machine 501 in clock pulse periods T8 and T11, to finite state machine 502 in clock pulse periods T9 and T12, and to finite state machine 503 in clock pulse periods T10 and T13. Finally, in phase 4, two finite-state automata 502 und 503 access the two channels A and B of the communications module, so that access to finite state machine 502 is distributed among clock pulse periods T14 and T16 and, to finite state machine 503, among T15 and T17.

Thus, arbiter finite-state automaton AFSM 500 ensures that, for the case when more than one of the three state machines makes a request to access to message memory 300, the access is allocated in a clocked and alternating process among the requesting state machines. This procedure safeguards the integrity of the message objects stored in the message memory, thus the data integrity. If, for example, host CPU 102 would like to read out a message object via output buffer 202 precisely at the moment when a received message is being written into this message object, then, depending upon which request was started first, either the old state or the new state is read out, without the accesses in the message object in the message memory itself colliding.

The described method allows the host CPU, during continuous operation, to read or to write any given message object in or into the message memory without the selected message object being blocked from participating in the data exchange on both channels of the FlexRay bus for the duration of the access by the host CPU (buffer locking). At the same time, the integrity of the data stored in the message memory is safeguarded by the clocked interleaving of the accesses, and the transmission rate is increased, also due to utilization of the full bandwidth.

FlexRay ASC Protocol Stage 2

In the context of the above description, example embodiments of the present invention provide a method and a device for transmitting data between a microprocessor (HOST) and a peripheral device, for example for communication purposes, in particular within FlexRay, as are used, inter alia, for controlling internal combustion engines. Often, there are only limited resources available for this type of data transmission, i.e., the bandwidth is limited. This is typically the case when a serial interface is used. The asynchronous and/or synchronous, in particular serial interface (ASC) 107 for the FlexRay controller links configuration 104, respectively corresponding submodule 204, via CPU interface 107 as a peripheral unit to host 102. The significance of the transmitted information is established by a protocol, as described preferably (but not exclusively) by the FlexRay protocol. Such a protocol typically includes the following elements:

1) a flag for the access procedure (reading/writing)

2) an address for the access location

3a) a counter for the number of data words to be transmitted or

3b) a flag which determines whether the address is increased following the access and is thus automatically available for the next access; and

4) optionally, the size of the address increment.

A protocol instruction having the elements 1) through 4) may be described as a simple command. Such a command is useful and proves to be efficient when the data to be transmitted are sequentially stored, respectively are to be sequentially stored. However, if the accesses are not able to be carried out in sequential order, these simple commands generate an overhead, whose execution strains the memory and computational resources of the host CPU. In data transmission, overhead is considered to be those data which do not count primarily among the useful data, but rather which are needed as supplementary information for transmission or storage purposes.

In the case that addresses need to be accessed which are not directly consecutive or whose intervals are irregular, the simple commands require transmitting new address information over and over again.

In the case that individual bits become corrupted during the transmission, when the simple commands are used, either a false location is accessed, or reading and writing are even interchanged.

To be able to attain a higher data throughput, in the context of example embodiments of the present invention, additional information is accessed for the data transmission, such as:
internal status information (for example, ready/busy state/bits);
information on bit fields (for example, limits);
predefined values (reduce redundancy);
predefined sequences of simple commands (reduce redundancy);
results of a CRC test, to ensure that commands and addresses are error-free.

To enhance the efficiency of accesses outside of the series and also for mixed write and read accesses, a protocol is created in the form of a hardwired sequencer or using a programmable sequencer. The hardwired sequencer consumes less resources (for example, memory capacity) and is less expensive. Moreover, it has advantages with respect to reliability of operation, and its application is simpler. On the other hand, the programmable sequencer is more efficient and flexible than the hardwired sequencer.

Practical analyses of the data transmission using a FlexRay communications module assist in identifying the most commonly used sequences and the corresponding simple commands. These are implemented in the (hardwired or programmable) sequencer and may be invoked in a simple manner. Thus, a plurality of simple commands are combined into at least one complex command, it being possible to invoke each complex command using fewer instructions than it is for the simple commands contained therein. Moreover, fewer resources are required to execute the complex commands than are to execute the individual simple commands contained therein.

A complex command may contain the following simple commands, for example, in accordance with the protocol:

Complex command in accordance with example a)
transmitting a certain number (defined in a bit field of the command) of data into a specified address range of a register, incrementing of the address;
transmitting a preset number of data into another specified address range of a register, incrementing of the address;
writing a few bits into one address of a register, the bit values being extracted by the command from predefined bit fields, filling the remaining bits with predefined values;
writing a few bits into one address of another register, the bit values being extracted by the command from predefined bit fields, filling the remaining bits with predefined values;
wait for the preceding sequence to end (hardware could be blocked).

Complex command in accordance with example b)
writing a few bits into one address of a register, the bit values being extracted by the command from predefined bit fields, filling the remaining bits with predefined values;
writing a few bits into one address of another register, the bit values being extracted by the command from predefined bit fields, filling the remaining bits with predefined values;
wait for the preceding sequence to end (hardware could be blocked) by sampling one or a plurality of bits;
copying internal data into a transfer buffer;
transmitting a certain number (defined in a bit field of the command) of data into a specified address range of a register, incrementing of the address;
transmitting a preset number of data into another specified address range of a register, incrementing of the address.

When example embodiments of the present invention are considered from a more generic perspective, a state machine is configured by a complex command, and the execution of the simple commands contained therein is triggered by the state machine. The model of a programmer for a complex command would be a “read buffer” or a “write buffer and configuration,” for example. An example of a complex “read buffer and status” command is provided in the following, to realize the desired functionality, instead of the 16 simple commands FlxrEray_Read respectively, FlxrEray_Write in the first block, only one single complex command FlxrEray_AscReadOutputBuffer being required in the second block.

#if (FLXR_INTERFACE_TYPE == Blockl)

// allocate data from the buffer for reading
// request buffer and header data (management)
while (Oul != (FlxrEray_Read(0x0714) & 0x00008000u1))
{

;

}
FlxrEray_Write(0x0710, mask_value);
FlxrEray_Write(0x0714, cmd_value);
while (((wait_obsys != 0ul) || (view == 1ul)) &&

((FlxrEray_Read(0x0714) & 0x00008000ul) != 0ul))

{

;

}
// make buffer visible
while (0ul != (FlxrEray_Read(0x0714) & 0x00008000u1))
{

;

}
FlxrEray_Write(0x0710, mask_value1);
FlxrEray_Write(0x0714, cmd-value1);
while (((wait_obsys != 0ul) || (view == 1ul)) &&

((FlxrEray_Read(0x0714) & 0x00008000ul) != Oul))

{

;

}
FlxrEray_ReceivedFrames[msgBudIdx_u32].headerSection.
headerSection1.valHDR1 = FlxrEray_Read(RDHS1);
FlxrEray_ReceivedFrames[msgBudIdx_u32].headerSection.
headerSection2.valHDR2 = FlxrEray_Read(RDHS2);
FlxrEray_ReceivedFrames[msgBudIdx_u32].headerSection.
headerSection3.va1HDR3 = FlxrEray_Read(RDHS3);
FlxrEray_ReceivedFrames[msgBudIdx_u32].reg_MBS.MBS_u32
= FlxrEray_Read(MBS);
// if frame lost or faulty, do not copy data
// useful data:
FlxrEray_ReceivedFrames[msgBudIdx_u32].Data[0]
= FlxrEray_Read(RDDS1);
FlxrEray_ReceivedFrames[msgBudIdx_u32].Data[1]
= FlxrEray_Read(RDDS2);
FlxrEray_ReceivedFrames[msgBudIdx_u32].Data[2]
= FlxrEray_Read(RDDS3);
FlxrEray_ReceivedFrames[msgBudIdx_u32].Data[3]
= FlxrEray_Read(RDDS4);

#elif (FLXR_INTERFACE_TYPE == Block2)

FlxrEray_AscReadOutputBuffer(messageTable[msgBudIdx_u32].
index_u8, &FlxrEray_ReceivedFrames[msgBudIdx_u32].Data[0],
4ul);

#endif

Altogether 16 accesses are required for execution of the individual simple commands, whereas merely one access is needed for execution of the one complex command. In some measure, the complex commands correspond to a type of function, in the context of the function, all individual simple commands not being simply executed one after another. Rather, the execution of the individual simple commands is optimized taking into consideration (empirical or theoretical) knowledge on the sequence, and the optimized version is stored as a complex command in such a way that fewer resources (computing power and memory capacity) of the host CPU and less time are required to invoke and execute the complex command than to invoke and sequentially execute all individual simple commands.

An example of a complex “write buffer and status” command is provided in the following, to realize the desired functionality, instead of the twelve simple commands FlxrEray_Read respectively, FlxrEray_Write in the first block, only one single complex command FlxrEray_AscWriteInputBuffer being required in the second block.

#if (FLXR_INTERFACE_TYPE == MLI)

// transmitting input buffer register in message memory
FlxrEray_Write(WRHS1, FlxrE-

ray_TransmitFrames[i_u32].headerSection.headerSection1.va
lH DR1);

FlxrEray_Write(WRHS2, FlxrE-

ray_TransmitFrames[i_u32].headerSection.
headerSection2.valH DR2);

FlxrEray_Write(WRHS3, FlxrE-

ray_TransmitFrames[i_u32].headerSection.headerSection3.va
lH DR3);

// only for transmitting the dummy useful data
if (1ul == cfg)
{

// write dummy data area
FlxrEray_Write(WRDS1, FlxrE-
ray_TransmitFrames[i_u32).Data[0]);
FlxrEray_Write(WRDS2, FlxrE-
ray_TransmitFrames[i_u32].Data[1]);
FlxrEray_Write(WRDS3, FlxrE-
ray_TransmitFrames[i_u32].Data[2]);
FlxrEray_Write(WRDS4, FlxrE-
ray_TransmitFrames[i_u32).Data[3]);

}
// Wait always until IBSYH (host buffer) = ‘0’, because the
IBCR cannot accept a new command as long as it is ‘1’
while (Oul != (FlxrEray_Read(IBCR) & 0x00008000ul))
{

;

}
// Set the command mask
FlxrEray_Write(IBCM, value);
// Program the target message memory and start transmission
FlxrEray_Write(IBCR, ibrh & 0x3Ful);
// Wait for IBSYH (host), if necessary
while ((wait_ibsyh != 0ul) && ((FlxrEray_Read(IBCR) &

0x00008000ul) != Oul))

{

;

}
// Wait for IBSYS (shadow memory), if necessary
while ((wait_ibsys != Oul) && ((FlxrEray_Read(IBCR) &

0x80000000u1) != Oul))

{

;

}

#elif (FLXR INTERFACE_TYPE == ASC)

FlxrEray_AscWriteInputBuffer(bufferIndex,

&FlxrEray_TransmitFrames[i_u32].Data[0], 4ul);

#endif

Altogether 12 accesses are required for execution of the individual simple commands, whereas merely one access is needed for execution of the one complex command. In this example as well, the execution of the individual simple commands is optimized in such a way that fewer resources (computing power and memory capacity) of the host CPU and less time are required to invoke and execute the complex command than to invoke and sequentially execute all individual simple commands.

The FlexRay protocol tailored to the special application case allows very efficient accessing of the transmit and receive buffer with respect to host interface 102-107-104. The interface module provided in this context is composed of parts 203 und 204, as already mentioned. The results of a detailed transactional analysis are used in such a way that the most frequent complex actions are mapped onto a simple command composed of a few elements.

Moreover, the command may be safeguarded by a CRC or parity in such a way that any corruption changing a read access into a write access or any corruption of the address is discovered in all probability still before the command is executed, thereby preventing a faulty execution or a fault propagation.

Several advantages are obtained:

On the one hand, the access becomes faster because the protocol in question has the knowledge of the configuration of the data, the access procedures, and the corresponding addresses in the form of a further finite-state automaton, which is hardwired, making it possible to automatically provide the configuration of the data, the access procedures and/or the corresponding addresses, so that they no longer need to be supplied by the host and thus no longer need to be transmitted via interface 107, i.e., specifically via line 216 through 218.

In addition, the access procedure (reading/writing) may already be permanently incorporated in this device, thus, as already mentioned, likewise no longer need to be transmitted.

Instead, these sequences, which are predefined with respect to the mentioned information (data configuration, access procedure, and/or addresses), are merely still retrieved and provided with additional values.

At this point, to retrieve such a predefined sequence, the protocol is expanded by the following element in accordance with example embodiments of the present invention: To that end, a value is introduced for the type of sequence to be retrieved and is named “access type marker, ATM,” for example, and describes the access type still to be described in the following.

The protocol in question also uses information for safeguarding the data, for example a CRC, respectively a parity, this safeguarding information being provided over at least the command portion (for example, the first three bytes) to ensure that a potential transmission error does not lead to corruption of an address or to a change in the access procedure (reading/writing). Corruption in the data area may be detected, as needed, using a read back process; this is not possible for addresses, respectively for the access procedure or the “access type marker.” This safeguarding, implemented, for example as a CRC or a parity, may also be performed using the first portion of the sequence, thus the command (for example, 6 bit CRC).

Examples of a sequence portion including exemplary indication of the bit number

| | ATM | R/W | Addr | Cnt | reserved | STRXY | CRC |
|---|---|---|---|---|---|---|---|
| number of | 2 | 1 | 6 | 6 | 2 | 1 | 6 |
| bits | | | | | | | |

| | ATM | R/W | Addr | Cnt | CRC |
|---|---|---|---|---|---|
| number of | 2 | 1 | 9 | 6 | 6 |
| bits | | | | | |

The following properties are presented exemplarily for the protocol of this interface, referred to as customer CPU interface (PROTOCOL):
half-duplex 8-bit synchronous operation
9.38 Mbaud, synchronization, no parity check
bus clock frequency (BCLK) 32 MHz
an interrupt request line
CRC via the command word
test byte synchronization
restoration of synchronization by the host
asynchronous reset

The protocol described here may convert serial transmitted and received data into 32-bit read and write accesses for a serial interface, for example, these accesses reading or writing via synchronous transactions from/to the internal registers of the customer CPU interface (CIF), the RAM of the communications module core (of the so-called core) and its register in an 11- or 12-Bit address space, for example.

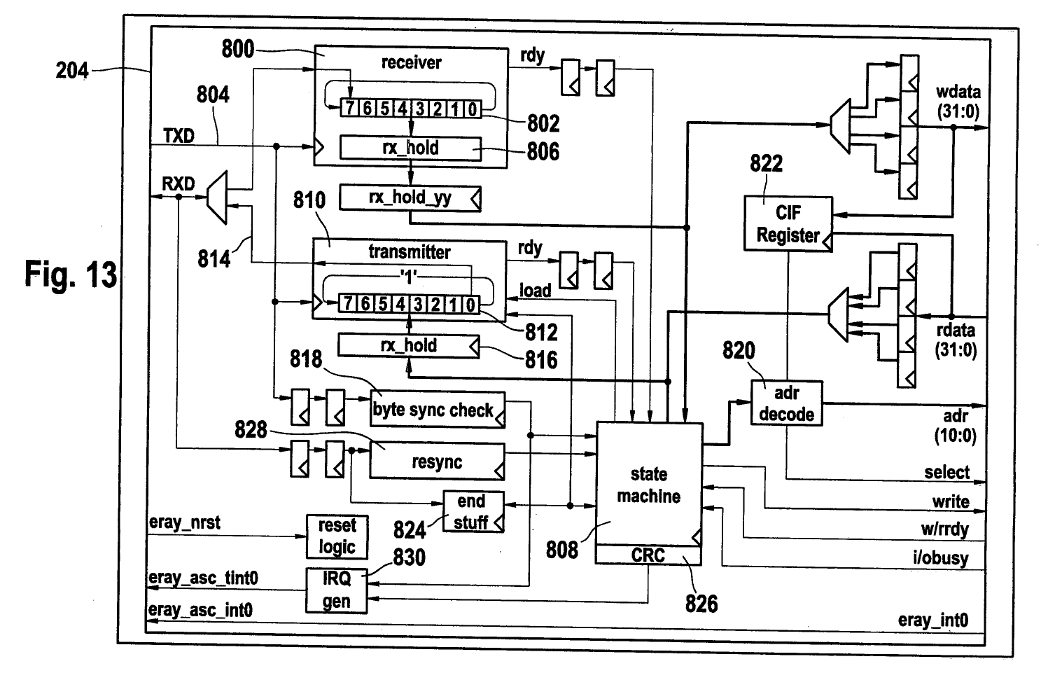

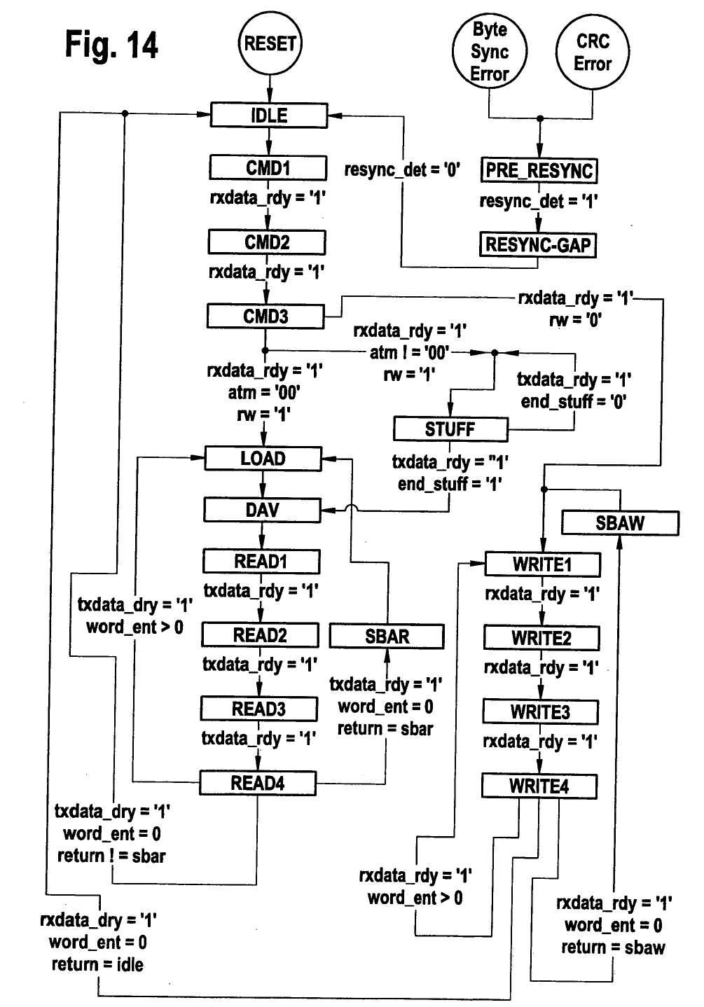

FIG. 13 shows a simplified structure of the ASC customer CPU interface 204 for transmitting and receiving specific predefinable commands for implementing the data transmission between communications link 101 and participant 102. In response to the rising edge of a TXD clock signal 804, the reception takes place in a receiver 800 through a shift register 802. Following eight clock cycles, the result is passed into a register rx_hold 806, and a rdy signal is set to inform state machine 808 that a new message is contained in rx_hold register 806. The test for byte synchronization (byte sync check) in function block 818 is likewise carried out at this point in time.

Bit ‘0’ is applied by transmitter 810, provided it is active, from its shift register 811 to an RXD line 814. With each falling edge of TXD clock signal 804, the received data are passed into shift register 812, and the data in register 812 are shifted further by one field (a so-called shift is executed). Following eight clock pulses, the rdy signal is set, and state machine 808 may load new data from a tx_hold register 816 into shift register 812.

The address decoder in functional block 820 makes the distinction between an internal CIF register 822 and an external memory of communications module 100. State machine 808 first reads three bytes of the command, before it begins to evaluate the command. The bits of the CRC are checked in a block 826. A write or read operation, an address access, or a simple buffer access are initiated as a function of the command. In a functional block “end stuff” 824, the end of an access of the communications module core is recognized, which blocks the ASC command, and then returns a last filler byte !=0x00. In the case of an error (CRC 826 or byte synchronization 818), state machine 808 enters into a reset state (resync) 828, optionally initiates an interrupt request (IRQ) 830 and waits for resynchronization (resync) 828 by host CPU 102. The state diagram in FIG. 14 shows the possible transitions in a simplified form:

Following the reset, state machine 808 resides in the IDLE state. If a transmitting error is recognized (byte synchronization error (byte sync error) or CRC error), state machine 808 is then driven into the PRE_RESYNC state.

The simplified actions in the respective states are:
IDLE Start receiver, end current access of the communications module core, reset all counters, etc.;
PRE_RESYNC Switch off receiver and transmitter, clear, i.e., reset local signals and states;
RESYNC_GAP Wait for the end of resynchronization by the host;
CMD1 Wait for receipt of the first byte of the command word;
CMD2 Wait for receipt of the second byte of the command word;
CMD3 Wait for receipt of the last byte of the command word. Check CRC, atm, rw, buffer_id, addr, word_cnt and useful data (payload) are evaluated. The return state is set and the filler bytes are started as a function of atm and rw, or the first word is read out from the communications module core;
STUFF Transmit 0x00 to the host. Repeat for as long as eray_obusy is high. (note: E-Ray is the internal designation of communications module 100 by the applicant)
LOAD End the current read access to the communications core. Activate transmitter 810.
DAV Data are available; copy the first byte into tx_hold register 816. Increase address.
READ1 Copy the second byte into tx_hold register 816.
READ2 Copy the third byte into tx_hold register 816.
READ3 Copy the last byte into tx_hold register 816.
READ4 Reduce word_cnt in the case >0
SBAR Read one single buffer (single buffer access read). Set the address (addr) to 0x700 (header).
WRITE 1 End the current write access to the communications module core. Copy the first byte from the register rx_hold_yy.
WRITE2 Copy the second byte from rx_holdyy.
WRITE3 Copy the third byte from rx_hold_yy.
WRITE4 Copy the last byte from rx_hold_yy. Write the word into the communications module core. Increase the address (addr), reduce word counts (word_cnt) in the case >0 or activate IBCM/IBCR accesses and switch on receiver 800.
SBAW End the current write access to the communications module core. Set the address (addr) to 0x500 (header).

In the case that a buffer read access to a single buffer takes place (single buffer access read), three communications module core accesses must have taken place, while filler bytes (‘0’) are transmitted to the host. Following a buffer write access (single buffer access write) to a single buffer, the ASC interface must execute two core accesses.

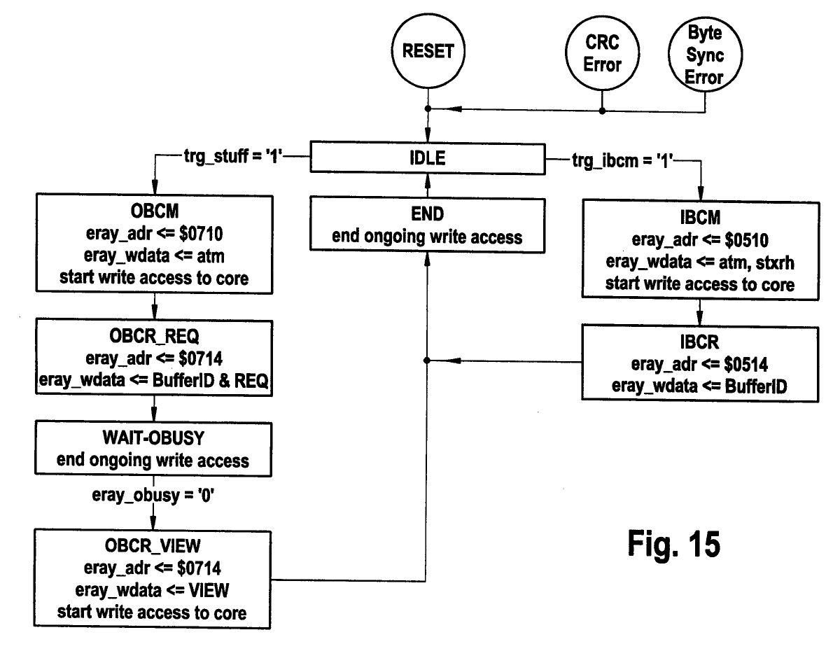

FIG. 15 shows state machine 808 for communications module core accesses (single buffer access read, write).

To check the validity of the commands, the command word is checked using a 6 bit CRC (cyclic redundancy check). The command word is 24 bits long and is composed of 18 bits command and 6 bits CRC.
D[17:0] data of the command word
CRC[5:0] CRC of the command word

The following polynomial initialized to 0 is used for the CRC, for example: x⁶+x⁵+x⁴+x+1.

A parallel implementation is used and results in the following equations:

CRC0:=D17̂D15̂D14̂D13̂D9̂D8̂D5̂D4̂D3̂D1̂D0;

CRC1:=D17̂D16̂D13̂D10̂D8̂D6̂D3̂D2̂D0;

CRC2:=D17̂D14̂D11̂D9̂D7̂D4̂D3̂D1;

CRC3:=D15̂D12̂D10̂D8̂D5̂D4̂D2;

CRC4:=D17̂D16̂D15̂D14̂D11̂D8̂D6̂D4̂D1̂D0;

CRC5:=D16̂D14̂D13̂D12̂D8̂D7̂D4̂D3̂D2̂D0;

Address Access
atm[1:0] access type (access type marker) “00”
rw read (‘1’) or write access (‘0’)
addr[8:0] start address, begins at a 32 bit word limit, 2 kilobyte address space
word_cnt[5:0] number of words-1 to be transferred
CRC[5:0] CRC via the command word

In the case that rw=‘0’, the protocol waits for 4*(word_cnt+1) bytes, in order to write these into the communications module core, beginning with the address (addr) as 32 bit words into the communications module core. In the case that rw=‘1’, the ASC interface reads the first 32 bit word out of the communications module core from the address (addr). This takes longer than the normal delay of a transmission cycle between the bytes. For that reason, the host must delay the switchover of the RxD line direction (from transmit to receive) by at least 2 TxD cycles. All of the subsequent bytes are transmitted quite normally. The ASC interface transmits 4*(word_cnt+1) bytes to the host CPU. Once the transmission is complete, the ASC interface waits for the next command.

As mentioned above, access types are described exemplarily:

Single Buffer Access

In the case that the host CPU would like to read via the protocol of the ASC interface, then the ASC interface must request the corresponding buffer from the communications module core. The response to this request takes some time and is not ready at a specific point in time. The point in time is dependent on the momentary capacity utilization of the communications module core. To indicate to the host that the data are not yet ready for transfer, the ASC interface transmits filler bytes (0x00) while it waits for the data. As soon as the data are ready, the ASC interface transmits the last filler byte !=0x00. The next byte is then already the least significant byte of the first data word to be transmitted.

Only Header
atm[1:0] access type (access type marker) “10”
rw read (‘1’) or write access (‘0’)
Buffer_ID[5:0] start address at a 32 bit word limit, 2 Kbyte address space
stxrh In the case that the buffer is written, set the transmission request host (STXRH) in the IBCM
rsv reserved, all ‘0’
CRC[5:0] CRC via the command word

In the case that rw=‘0’, the protocol of the ASC interface waits for 4*4(header) bytes, in order to write these as 32 bit words into the communications module core, beginning with the address 0x0500 (header input buffer). Following the last write access, the following actions are carried out by the protocol:

1. write atm (LHSH) and stxrh to address 0x0510 (IBCM)

2. write buffer_ID to address 0x0514 (IBCR)

In the case that rw=‘1’, the protocol of the ASC interface begins to transmit filler bytes (0x00) to the host. The ASC interface needs this time to request the corresponding header from the communications module core. While these filler bytes are transmitted, the following actions are carried out by the protocol:

1. Write atm (header) to address 0x0710 (OBCM)

2. Write buffer_ID and REQ to address 0x0714 (OBCR)

3. Wait until eray_obusy is low again.

While eray_obusy is high, the communications module core copies the corresponding header into the output buffer.

4. Write VIEW to address 0x0714 (OBCR)

At this point, the corresponding header is available in the output buffer. Once the filler bytes have been transmitted, the protocol of the ASC interface 4*4 (header) transmits bytes to the host. After this command is ready, the protocol of the ASC interface waits for the next command.

Only Useful Data
atm[1:0] access type (access type marker) “01”
rw read (‘1’) or write access (‘0’)
useful data[5:0] number of 32 bit words+1
buffer_ID[5:0] start address at a 32 bit word limit, 2 Kbyte address space
stxrh In the case that the buffer is written, set the transmission request host (STXRH) in the IBCM.
rsv reserved, all ‘0’
CRC[5:0] CRC via the command word

In the case that rw=‘0’, the ASC interface waits for 4*(useful data+1) bytes, in order to write these as 32 bit words into the communications module core, beginning with the address 0x0400 (input buffer). Following the last write access, the following actions are carried out by the protocol of the ASC interface:

1. write atm (LDSH) and stxrh to address 0x0510 (IBCM)

2. write buffer_ID to address 0x0514 (IBCR)

In the case that rw=‘1’, ASC interface transmits filler bytes (0x00) to the host. The protocol of the ASC interface needs this time to request the corresponding useful data from the communications module core. While the filler bytes are transmitted, the following actions are carried out by the protocol of the ASC interface:

1. Write atm (useful data) to address 0x0710 (OBCM)

2. Write buffer_ID and REQ to address 0x0714 (OBCR)

3. Wait until eray_obusy is low again.

While eray_obusy is high, the communications module core copies the corresponding useful data into the output buffer.

4. Write VIEW to address 0x0714 (OBCR)

At this point, the corresponding useful data are available in the output buffer. Once the filler bytes have been transmitted, the protocol transmits 4*(useful data+1) bytes to the host. After this command is ready, the protocol of the ASC interface waits for the next command.

Useful Data and Header
atm[1:0] access type (access type marker) “11”
rw read (‘1’) or write access (‘0’)
useful data[5:0] number of 32 bit words+1
buffer_ID[5:0] start address at a 32 bit word limit, 2 Kbyte address space
stxrh In the case that the buffer is written, set the transmission request host (STXRH) in the IBCM.
rsv reserved, all ‘0’
CRC[5:0] CRC via the command word

In the case that rw=‘0’, the protocol of the ASC interface waits for 4*(useful data+1) bytes, in order to write these as 32 bit words into the communications module core, beginning with the address 0x0400 (input buffer), and waits for 4*4(header) bytes, in order to write these as 32 bit words into the communications module core, beginning with the address 0x0500 (header). Following the last write access, the following actions are carried out by the protocol:

1. Write atm (LHSH, LDSH) and stxrh to address 0x0510 (IBCM)

2. Write buffer_ID to address 0x0514 (IBCR)

In the case that rw=‘1’, the protocol of the ASC interface transmits filler bytes (0x00) to the host. The protocol needs this time to request the corresponding useful data and header from the communications module core. While the filler bytes are transmitted, the following actions are carried out by the protocol:

1. Write atm (useful data and header) to address 0x0710 (OBCM)

2. Write buffer_ID and REQ to address 0x0714 (OBCR)

3. Wait until eray_obusy is low again.

While eray_obusy is high, the communications module core copies the corresponding useful data and header into the output buffer.

4. Write VIEW to address 0x0714 (OBCR)

At this point, the corresponding useful data and header are available in the output buffer. Once the filler bytes have been transmitted, the protocol of the ASC interface transmits 4*(useful data+1+4(header)) bytes to the host. After this command is ready, the ASC interface waits for the next command.

Resynchronization

This is not a command that has an assigned specific command word. The host CPU may drive the ASC interface into the resynchronization state, in that the RxD line is pulled low for at least 29 TxD cycles, without the TxD line actually having to be driven. In normal operation (host CPU is transmitting), the RxD line becomes high when each byte has been transmitted.

The ASC interface will stop the current operation, clear internal signals and states and wait for the next command which is transmitted by the host CPU.

1-14. (canceled)

15. A FlexRay communications module for coupling a FlexRay communications link, over which messages are transmittable, to a participant, which is assigned via a participant interface to the FlexRay communications module, comprising:
a configuration adapted to store messages at least one of (a) transmitted and (b) to be transmitted between the participant and the FlexRay communications link; and
a state machine which, to control the transmission of the messages, is adapted to at least one of (a) specify and (b) invoke sequences relating to information for storing messages in the configuration, for invoking messages from the configuration, and for transmitting the messages.

16. The FlexRay communications module according to claim 15, wherein the state machine is hardwired in hardware.

17. The FlexRay communications module according to claim 15, wherein the sequences are hardwired in hardware.

18. The FlexRay communications module according to claim 15, wherein the state machine is freely programmable by the participant via the participant interface.

19. The FlexRay communications module according to claim 15, wherein the information includes at least one of (a) an access type, (b) an access procedure, (c) an access address, (d) a data size, (e) control information pertaining to data, and (f) at least one piece of information pertaining to data protection.

20. A FlexRay communications controller for coupling a FlexRay communications link, over which messages are transmittable, to a participant, which is assigned via a participant interface to the FlexRay communications controller, comprising:
a FlexRay communications module including:
a configuration adapted to store messages at least one of (a) transmitted and (b) to be transmitted between the participant and the FlexRay communications link; and
a state machine which, to control the transmission of the messages, is adapted to at least one of (a) specify and (b) invoke sequences relating to information for storing messages in the configuration, for invoking messages from the configuration, and for transmitting the messages.

21. A method for transmitting messages between a FlexRay participant and a FlexRay communications link, a FlexRay communications module communicating with the communications link, and the participant connected via a participant interface to the communications module, comprising:
buffer storing in a configuration of the FlexRay communications module messages at least one of (a) transmitted and (b) to be transmitted between the participant and the FlexRay communications link; and
in order to control transmission of the messages, at least one of (a) specifying and (b) invoking sequences relating to information for storing messages in the configuration, for invoking messages from the configuration, and for transmitting the messages.

22. The method according to claim 21, further comprising defining, in the FlexRay communications module, simple commands for configuring, for initiating and for controlling data transmission between the participant and the FlexRay communications link, each of the sequences fulfilling a functionality of a plurality of simple commands.

23. The method according to claim 22, further comprising optimizing commands of a sequence, while the functionality of the sequence is retained with respect to a reduction in at least one of (i) a number of invocations required, in resources, including at least one of (a) memory capacity and (b) computing power, required of the participant and (ii) in processing time required, taking into consideration advance knowledge of the data transmission, of details of the FlexRay communications module.

24. The method according to claim 23, wherein the commands of a sequence are optimized prior to at least one of (a) an actual data transmission and (b) an execution of the sequence.

25. The method according to claim 23, wherein the advance knowledge is acquired at least one of (a) on the basis of a transmission protocol used and (b) on the basis of other information prior to an actual data transmission.

26. The method according to claim 23, wherein the advance knowledge is acquired through practical analyses of a corresponding data transmission prior to the actual data transmission.

27. The method according to claim 21, wherein the sequences in the FlexRay communications module are at least one of (a) hardwired and (b) programmed prior to an actual data transmission.

28. The method according to claim 21, wherein the simple commands each include at least one of:
(i) a flag, including at least one bit, for an access procedure, including at least one of (a) block reading/writing, (b) management data, and (c) useful data;
(ii) an address, including a plurality of bits, for an access location;
(iii) a counter for a number of data words to be transmitted; and
(iv) a flag which stipulates whether data following an access are to be transmitted via the FlexRay communication link (101);
(v) a cyclic redundancy check; and
(iv) a checksum.
